(19) United States
(12) Patent Application Publication
(10) Pub. No.: US 2005/0141351 A1
(43) Pub. Date: Jun. 30, 2005

(54) Recording type optical disk apparatus and optical disk medium

(75) Inventor: Yutaka Yamanaka, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/962,712

(22) Filed: Oct. 13, 2004

(30) Foreign Application Priority Data
Oct. 14, 2003 (JP) 353385/2003

(51) Int. Cl. G11B 21/08

(52) U.S. Cl. 369/30.01; 369/59.25

(57) ABSTRACT

An optical disk medium including a lead-in area and a data recording area. The data recording area includes a user data area where a user data is recorded which is to be recorded by a user, and a control data area where a control data is recorded, the control data being used in an access control operation of the optical disk medium.

### BACKGROUND OF THE INVENTION

1. Field of the Invention

The present invention generally relates to an optical disk apparatus. More specifically, the present invention is directed to a recording type optical disk apparatus capable of recording/reproducing data by using a very small optical spot-beam, and an optical disk medium utilized in the recording type optical disk apparatus.

2. Description of the Related Art

In an optical disk field for recording/reproducing data by using a very small optical spot-beam, CD-R (Compact Disk-Recordable) and DVD-R (Digital Versatile Disk-Recordable) disks corresponding to recording type optical disks on which are once capable of recording data have been widely popularized subsequent to a reproduction-dedicated ROM (Read-Only Memory) medium on which a data pit stream has been embossed.

In a recording type optical disk medium, a groove track having a spiral shape is formed in an optical disk and used in a tracking operation, and a recording layer made of organic material is formed on this spiral-shaped groove track as a multi-layer form. Since a laser beam of high power is focused onto this recording layer so as to record data by forming recording pits, partially altering the focused recording layer. After the data has been recorded on this recording type optical disk medium, since this recording type optical disk medium can have the same data format as that of a ROM medium formed by being embossed and can acquire such a servo signal having the substantially same characteristic as that of the ROM medium. Then, this recording type optical disk medium has an advantage that it can be readily reproduced by a reproduction-only drive apparatus.

For example, in the case of a DVD-R disk, only push-pull type track error signals caused by grooves are merely detected under unrecorded condition of this DVD-R disk. However, after data has been recorded on this DVD-R disk, track error signals can be detected by way of a phase difference detecting system from pits which are similar to those of a DVD-ROM disk.

Also, in such a DVD-R disk, such additional information as data IDs (addresses) and error corrections are added with respect to user data, and then, the resulting information is format-converted into a series of continuous data which will be recorded on an optical disk medium of this DVD-R disk. This continuously recorded format is identical to a format of a DVD-ROM disk.

However, if a format of a DVD-R disk is made completely identical to a format of a DVD-ROM disk, then data can be recorded on this DVD-R only one time. To avoid this restriction, such a recording/reproducing system called as a “multi-cession” has also been set by which data may be additionally recorded, as described in, for example, Japanese Laid-open Patent Application No. 2002-208139. In this multi-cession type recording/reproducing system, specific data called as a “border area” where information as to a data position has been recorded is recorded after user data, and thereafter, another user data is further recorded. A reproducing apparatus reproduces the user data while utilizing this positional information of the data.

In conjunction with the above-explained techniques, for instance, such an optical disk has been proposed in “OPTICAL DISK AND METHOD OF REPRODUCING THE SAME” opened in WO 03/107333 A1. That is, the optical disk is comprised of a recording track; the recording track contains a data recording area where a recording pit for recording data is formed, and a header area where a pre-pit is formed and is used to record header information for identifying the data recording area; the recording pit owns higher reflectance than that of a space where the recording pit is not formed; and both the recording pit and the pre-pit are formed in such a manner that when optical beams having the same light levels are entered to both the header area and the data recording area, an amplitude of a level of an optical signal reflected from the header area becomes larger than, or equal to an amplitude of a level of an optical signal reflected from the data recording area.

Also, an information recording medium is disclosed in Japanese Laid Open Patent Application (JP-P2001-291245A). In this conventional example, the information recording medium has coaxial information tracks or a spiral information track. The information recording medium has a first information area including a reproduction-only track, a second information area including a recordable/reproducible track, a boundary area including an incontinuous track between the first and second information areas, and a mark area. A mark is recorded in the mark area to indicate a boundary condition.

### SUMMARY OF THE INVENTION

An object of the present invention is to provide a recording type optical disk apparatus capable of recording over an entire surface of an optical disk medium with better recording condition, and also, to provide an optical disk medium used in the recording type optical disk apparatus.

Another object of the present invention is to provide a recording type optical disk apparatus capable of recording in correspondence with an aging effect as to peripheral environments during recording operation, and also, to provide an optical disk medium used in the recording type optical disk apparatus.

Another object of the present invention is to provide a recording type optical disk apparatus capable of realizing optimized recording operations with respect to areas whose recording speeds are different from each other, and also, to provide an optical disk medium used in the recording type optical disk apparatus.

A further object of the present invention is to provide a recording type optical disk apparatus capable of readily adjusting a recording condition while data is recorded on a recording type optical disk, and also, to provide an optical disk medium used in the recording type optical disk apparatus.

In an aspect of the present invention, an optical disk medium including a lead-in area and a data recording area. The data recording area includes a user data area where a user data is recorded which is to be recorded by a user, and a control data area where a control data is recorded, the control data being used in an access control operation of the optical disk medium.

Here, the optical disk medium may further include a flag area where a flag is recorded and provided to indicate that the control data has been recorded in the data recording area. In this case, the flag area may be provided for at least one pit.

Also, the data recording area may include a plurality of ECC (Error Correction Code) blocks, and the flag area may be provided in each of the plurality of ECC blocks. In this case, the flag area is provided in a head portion of each of the plurality of ECC blocks.

Also, the flag area may be provided in the lead-in area.

Also, an address table may be recorded in the lead-in area. When the flag indicates that the control data has been recorded in the data recording area, the control data may be recorded in an area which is indicated based on an address of the data recording area recorded in the address table.

Also, an address table may be recorded in the data recording area. When the flag indicates that the control data has been recorded in the data recording area, the control data may be recorded in an area which is indicated based on an address of the data recording area recorded in the address table. In this case, the address is indicated by a physical address of said optical disk medium, which has been previously formed. Also, the address may be indicated based on an ID (identification) for identifying each of the plurality of ECC blocks.

Also, the control data may contain a predetermined pattern data. In this case, the predetermined pattern data includes random data.

In another aspect of the present invention, an optical disk apparatus reproduces a user data from an optical medium including a lead-in area and a data recording area in which a recording data having the user data and a control data is recorded. An access unit is configured to read the recording data from the data recording area, and a control unit is configured to control the access unit such that the user data of the recording data is selectively read out from the optical medium.

In another aspect of the present invention, an optical disk apparatus records a user data on an optical medium including a lead-in area and a data recording area in which a recording data having the user data and a control data is recorded. An access unit is configured to record the recording data into the data recording area; and a control unit configured to change a recording condition of the access unit, when the control data is recorded on the data recording area. In this case, the optical disk apparatus may further include a host unit which outputs an instruction to the control unit such that the access unit carries out a training process before a recording process. The control unit determines an optimized recording condition of the access unit based on the changed recording condition.

Also, the control data and the user data are recorded on the data recording area of the optical medium by the access unit in response to the instruction from the host unit. The control unit controls the access unit to record a flag data on the optical medium, when the control unit detects that the control data and the user data are already recorded on the optical medium.

Also, the control unit controls the access unit in response to another instruction of the host unit to record the flag data in each of ECC blocks of the data recording area of the optical medium. In this case, the control unit controls the access unit in response to the other instruction from the host unit to record the flag data in a head portion of each of the ECC blocks of the data recording area.

Also, the control unit controls the access unit in response to another instruction of the host unit to record the flag data in the lead-in area of the optical media.

### BRIEF DESCRIPTION OF THE DRAWINGS

FIG. 1 is a block diagram showing the structure of an optical disk system according to the present invention;

FIG. 2 is a block diagram showing the structure of an optical disk apparatus according to the present invention;

FIG. 3 is a diagram showing a track structure of an optical disk medium according to a first embodiment of the present invention;

FIG. 4 is a diagram showing a logical structure of a record format on the optical disk medium according to the present invention;

FIG. 5 is a diagram showing the arrangement of ECC blocks of the optical disk medium according to the first embodiment of the present invention;

FIG. 6 is a diagram showing recording positions of control data on the optical disk medium according to a second embodiment of the present invention;

FIG. 7 is a diagram for schematically showing recording positions of a flag and an address table in the optical disk medium according to a third embodiment of the present invention;

FIG. 8 is a diagram showing the table structure of the address table of the optical disk medium according to the third embodiment of the present invention;

FIG. 9 is a diagram showing a modification of the third embodiment of the present invention;

FIGS. 10A to 10C are diagrams graphically showing a relationship between a tracking operation and a reproduction signal in the optical disk system of FIG. 1;

FIG. 11 is a diagram showing a relationship between recording laser power and an error in the optical disk system of FIG. 1;

FIG. 12 is a flow chart showing a recording operation of the optical disk apparatus according to the first embodiment of the present invention;

FIG. 13 is a flow chart showing a reproducing operation of the optical disk apparatus according to the first embodiment of the present invention;

FIG. 14 is a flow chart showing the recording operations of the optical disk apparatus according to the second embodiment of the present invention;

FIG. 15 is a flow chart showing a reproducing operation of the optical disk apparatus according to the second embodiment of the present invention;

FIG. 16 is a flow chart showing a recording operation of the optical disk apparatus according to the third embodiment of the present invention; and

FIG. 17 is a flow chart showing a reproducing operation of the optical disk apparatus according to the third embodiment of the present invention.

### DESCRIPTION OF THE PREFERRED EMBODIMENTS

Hereinafter, a data recording/reproducing system using an optical disk apparatus and an optical disk medium according to the present invention will be described in detail with reference to the attached drawings.

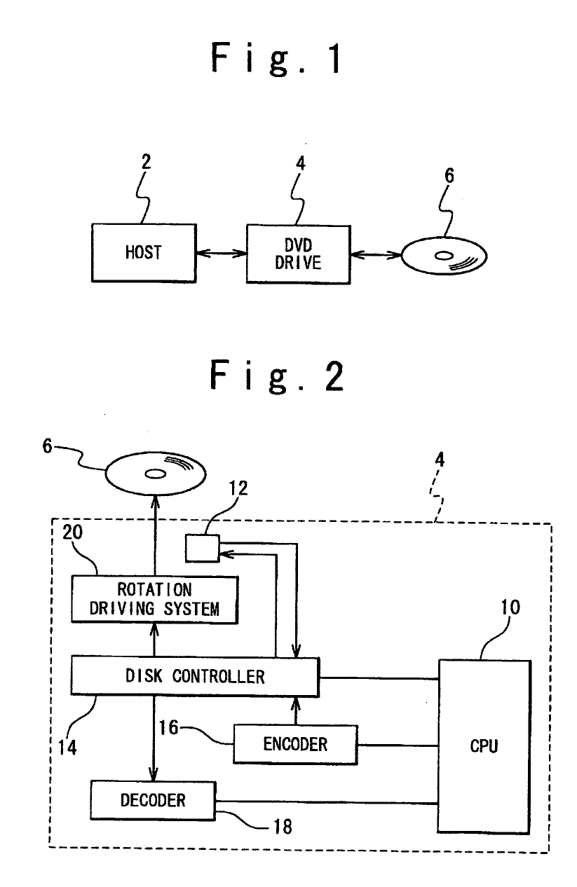

FIG. 1 is a diagram showing the structure of the data recording/reproducing system according to the present invention. In the data recording/reproducing system, an optical disk medium 6 such as a DVD (Digital Versatile Disk) is set to an optical disk apparatus 4. The optical disk apparatus 4 records data on the optical disk medium 6 in response to an instruction from a host apparatus 2, and reads out the data from the optical disk medium 6 in response to an instruction from the host apparatus 2. Also, the optical disk apparatus 4 carries out a training process for confirming and adjusting a writing condition before a writing operation in response to an instruction issued from the host apparatus 2.

FIG. 2 schematically shows the structure of the optical disk apparatus 4 according to the first embodiment of the present invention. Referring to FIG. 2, the optical disk apparatus 4 of the first embodiment is provided with a CPU (Central Processing Unit) 10, an access unit 12, a disk controller 14, an encoder 16, a decoder 18, and a rotation driving system 20.

The CPU 10 controls an entire operation of the optical disk apparatus 4. The CPU 10 transmits and receives instructions, notifications and to and from the host apparatus 2 and controls the disk controller 14, the encoder 16, and the decoder 18. Further, the CPU 10 carries out necessary calculating operations.

The access unit 12 uses a laser beam to write data on the optical disk medium 6 and to read data from the optical disk medium 6. It could be understood that the access unit 12 is well known by a person in the art. The rotation driving system 20 rotationally drives the optical disk medium 6 in response to an input command when the optical disk medium 6 is set.

The disk controller 14 controls the access unit 12 and the rotation driving system 20 in such a manner that rotation control/laser control and data read/write control are carried out to the optical disk medium 6. The disk controller 14 also controls the rotation driving system 20 in response to an instruction issued from the CPU 10 to rotate the optical disk medium 6. Also, the disk controller 14 controls a position of the access unit 12 in response to an instruction sent from the CPU 10. Further, the disk controller 14 controls the operations of the access unit 12 in a write mode and a read mode. In the write mode, the disk controller 14 controls the access unit 12 to write data supplied from the encoder 16 in the optical disk medium 6. The access unit 12 irradiates a laser beam onto the optical disk medium 6 to write data onto the optical disk medium 6. Also, in the read mode, the disk controller 14 controls the access unit 12 to read out data from the optical disk medium 6. The access unit 12 irradiates a laser beam onto the optical disk medium 6 to read data from the optical disk medium 6. The read data is supplied via the disk controller 14 to the decoder 18.

The encoder 16 carries out an encoding process to user data in response to an instruction issued from the CPU 10 to generate a write data in units of ECC blocks (16 sectors). The write data generated by the encoder 16 is supplied to the disk controller 14.

The decoder 18 carries out a decoding process to the data read out from the optical disk medium 6 in response to an instruction issued from the CPU 10, in units of ECC blocks (16 sectors).

In the recording type optical disk medium 6 such as DVD-R and DVD-RW, a groove track having a spiral shape is formed on an optical disk substrate for a tracking purpose. A recording layer is form of organic material on this optical disk substrate. Thus, a multi-layer structure is accomplished. A high power laser beam is focused onto this recording layer to partially modify the focused recording layer and to form recording pits. Thus, data can be recorded as the recording pits. After the data is recorded on the recording type optical disk medium 6, a data format of this optical disk medium 6 is equivalent to a data format of an optical disk ROM medium (DVD-ROM etc.) embossed. In this case, a servo signal having substantially the same characteristic as that of an optical disk ROM medium can be acquired from this recording type optical disk medium 6. Therefore, there is a merit that this recorded optical disk medium 6 can be readily reproduced even by a reproduction-only drive apparatus.

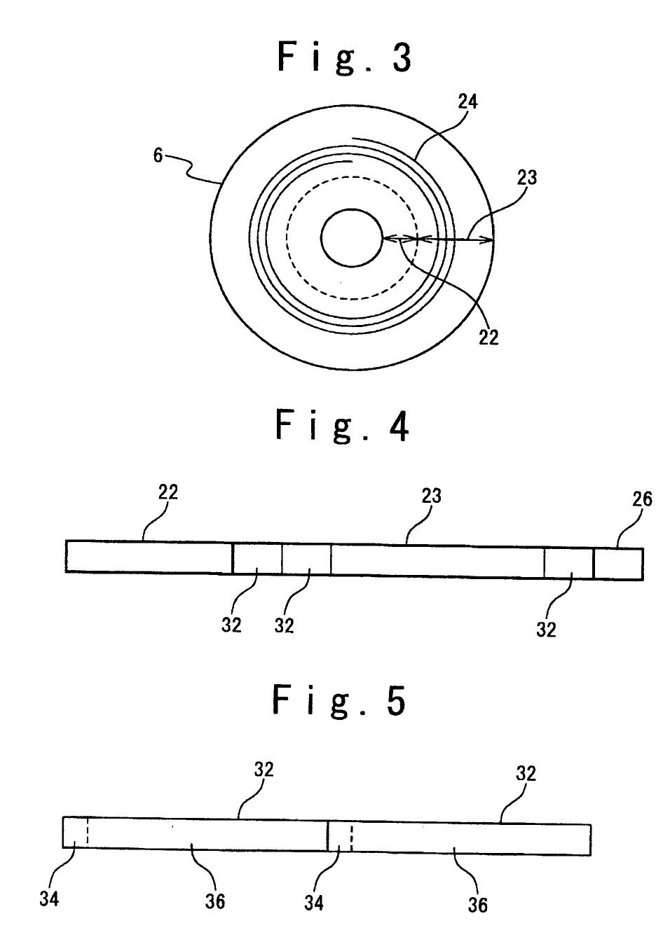

As shown in FIG. 3, the recording type optical disk medium 6 is provided with a lead-in area 22, a data recording area 23, and a read-out area (not shown) from the innermost area of this disk medium 6 to the outermost area thereof in a coaxial shape.

The lead-in area 22 contains information of the optical disk medium 6 (otherwise, information of a cession to which the lead-in area belongs) and information of tracks recorded by a user. In this lead-in area 22, an area for recording data used to control the optical disk medium 6 and another area used to carry out a recording condition test are secured. These data is referred to as “control data” hereinafter.

The read-out area is an area to indicate an end of the optical disk medium 6 (otherwise, end of cession). When the read-out area is detected, the end of the optical disk medium 6 (or end of cession) is recognized.

The data recording area 23 is located outside the lead-in area 22, and is used to record user data.

The recording track 24 having a spiral shape has been formed in the data recording area 23.

The data structure is shown in FIG. 4 in a one-dimensional manner. The data recording area 23 is located between the lead-in area 22 and the read-out area 26. In this data recording area 23, data is recorded every ECC (Error Correcting Code) block 32. The ECC block 32 is a unit used to record data of a user. As to the ECC block 32, various sorts of formats have been standardized in accordance with a use purpose.

In the first embodiment, a flag area 34 is secured every this ECC block 32. As shown in FIG. 5, one flag area 34 is secured in the vicinity of a head position of one ECC block 32. Although only two blocks of the ECC blocks 32 are shown in FIG. 5, the ECC blocks have been continuously recorded on a track. Data indicative of a mode is recorded on a head flag recording position of each of these ECC blocks 32. There are two modes, namely a normal mode and an advance mode. In the normal mode, a series of user data which have been encoded are recorded in a continuous manner. In the advance mode, the control data which does not contain user data is recorded for an access control in a recording operation.

When the flag recorded in the flag area 34 indicates the advance mode, the control data is recorded in a data area 36 of the ECC block 32. When the flag area 34 is secured in each of the ECC blocks 32, the mode can be set in each of the ECC blocks 32. Thus, positions used to record the control data can be set in a flexible manner.

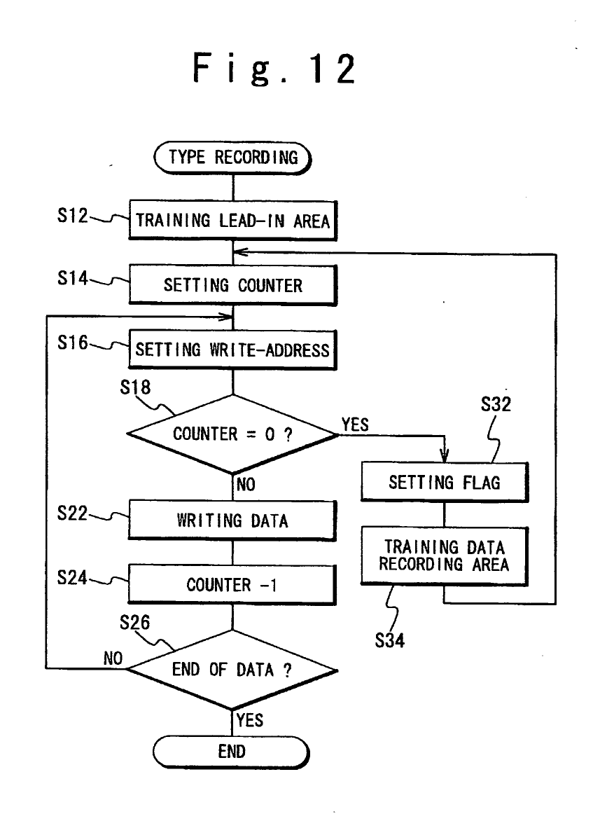

Referring to FIG. 12, an operation when data is recorded on the ECC type optical disk medium 6 in which the flag area 32 is secured in this ECC block 32 will be described below.

In the normal writing operation, a single writing operation is referred to as a cession. In a single cession, three recording areas of the lead-in area 22, the data recording area 23, and the read-out area 26 are combined with each other to constitute a united area. When one cession is in this optical disk medium 6, the writing operation is called as a “single cession”. On the other hand, when a plurality of cessions are completed in one optical disk medium 6, it is called as a “multi-cession.” In case that a rewritable area is still left in one optical disk medium 6 even when one cession is completed, data can be additionally written. When the data is additionally written in one optical disk medium 6, the resulting optical disk medium 6 becomes a multi-cession. If one optical disk medium 6 is formed as a multi-cession, then data can be additionally written thereinto as long as an empty storage area is present in this optical disk medium 6. In this embodiment, the “single cession” will be described.

First, the lead-in area 22 is written onto the optical disk medium 6. That is, data corresponding to an index is written into this lead-in area 22. An R-Information area as a specific area of a recording type optical disk medium is arranged on a head side of this lead-in area 22. In the R-information area, a power calibration area (PCA) for a calibration of recording laser beam power and a recording management area (RMA) for recording management data required for a recording appliance have been secured. Based upon the data of these areas, a calibration (training) of recording laser power is carried out to be set to an optimum recording condition (step S12). It should be noted that this R-information area is not reproduced by a reproducing appliance.

Subsequently, a user data is written onto optical disk medium 6. In the first embodiment, an advance mode is assumed in which the control data is recorded every “N” ECC blocks. Therefore, a counter (not shown) for counting the ECC blocks 32 is provided. The number of blocks “N” is set to this counter (step S14).

An address used to write the user data into the optical disk medium 6 is set to the disk controller 14 (step S16).

The counter is checked. If the count value of this counter is not equal to “0” (“NO” in step S18), then the process is determined to be the mode for writing the user data. Thus, the flag indicative of the normal mode and the user data are written in the ECC block 32 (step S22).

A total number of the ECC blocks 32 (“1” in this example) in which data is written is decremented from the counter, and the total number of the ECC blocks 32 in which the user data has been written in the normal mode is counted (step S24).

Whether or not all of the user data are written is checked (step S26). If the check result becomes “NO”, then the process from the step S16 up to the step S26 are repeatedly carried out until all of the user data are written.

When the counter is checked and the check result becomes “0” (“YES” in step S18), the process of the advance mode is carried out. First, a flag indicative of the advanced mode is written in a flag area 34 located in the vicinity of the head of the ECC block 32 (step S32).

By using the area of this ECC block 32, the calibration (training) of the recording laser power is carried out based on the control data of a specific pattern and the optimum recording condition is set (step S34). It could be understood that this training may be alternatively carried out over a plurality of the above-described EEC blocks 32.

When the training is accomplished, the recording operation is returned to the previous step S14 in which the number of blocks is set to the counter which counts until next advance mode is set. As previously described, the data recording operation is carried out when the flag area 34 is provided in the ECC block 32.

It should be noted that the flag indicative of the advance mode and the control data for the calibration can be written in a continuous manner. In this case, the flag may be assumed as a portion of the control data.

Apparently, the ECC block of the advance mode may be utilized for record of not only a calibration of recording laser power, but also other control data such as recording management data.

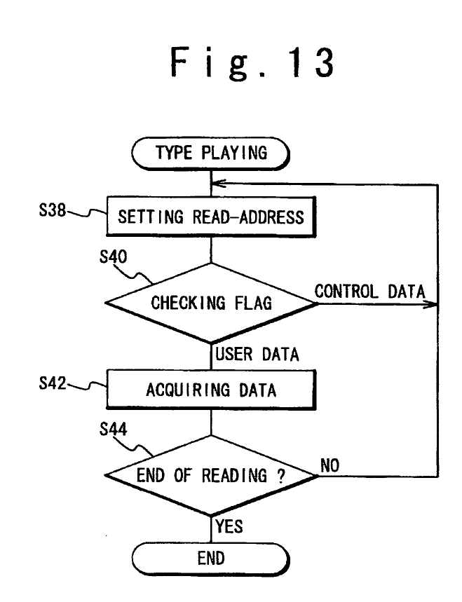

Next, a reproducing operation for reading out the data from the optical disk medium 6, which has been written in the above-described manner, will be described with reference to FIG. 13. The optical disk medium 6 is mounted on the optical disk apparatus 4, and a reproducing operation is commenced.

An address used to read user data is set to the disk controller 14 (step S38).

The flag area 34 located at the head of a read out ECC block 32 is checked (step S40). As a result of this check, if the flag indicates the normal mode and the user data has been recorded in the read out ECC block 32 (“user data” in step S40), then the user data is acquired from the read out ECC block 32 (step S42). On the other hand, the user data can be continuous, the above-mentioned reproducing operation is repeatedly carried out (“NO” in step S44).

As a result of the check, if the flag indicates the advance mode and the control data has been recorded in the read out ECC block 32 (“control data” in step S40), then the data recorded in the read out ECC block 32 is the control data. Because this control data need not be read, the reproducing operation is returned to the previous step S38 in which the reading operation is carried out to a next ECC block 32.

Since the data are read out while the flag is checked in the above-mentioned manner, the user data can be read out from the optical disk medium 6 in which the control data has been recorded such that the control data has been located between the user data.

Furthermore, data which indicates that this recording type optical disk medium 6 has both of the advance mode and the normal mode may be recorded in the recording management data stored in the lead-in area 22.

When the data indicating that a recording type optical disk medium has both of the advance mode and the normal mode has been recorded, the user data can be read in accordance with the above-mentioned reproducing operation. To the contrary, when the data indicating that the recording type optical disk medium has both of the advance mode and the normal mode has not been recorded, the user data can be read in accordance with the conventional reproducing operation, assuming that this optical disk medium is the conventional optical disk medium in which the ECC block does not contain the flag area 34. As a consequence, the optical disk medium 6 of the present invention and the optical disk medium having the conventional structure can be commonly used.

As previously mentioned, in case of a method for recording the control data in the data recording area 23, a track error signal can be detected which is equivalent to a track error signal in case that the user data has been recorded in the control data. For instance, in a DVD-ROM, it is defined that the track error signal in a phase difference detecting system maintains a value larger than or equal to a certain constant value. Also, if it is defined that a portion where the control data has been recorded satisfies this characteristic after the recording operation, only firmware used to determine an operation is merely changed without changing a major structural component such as an optical head in a reproducing apparatus. As a result, this may cause merits in cost.

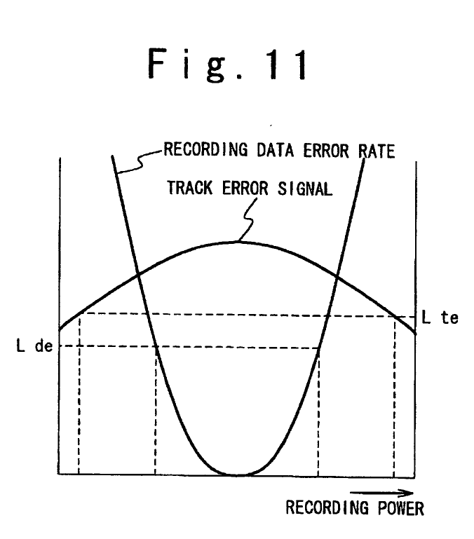

FIG. 11 is a diagram graphically showing a change of a recording data error rate and a change of a track error signal when the recording power is varied. The recording data error rate has a characteristic that the recording data error rate is suddenly deteriorated when the recording power exceeds a certain range, and changes in accordance with a so-called “bucket curve.” On the other hand, the change in the track error signal is gentler, as compared with the change in the recording data error rate.

In FIG. 11, the symbol “L de” shows an allowable level of the recording data error rate, and symbol “L te” represents an allowable level of the track error signal. The following fact can be revealed. That is, a range of recording power in which the track error signal is higher than or equal to the allowable level “L te” is wider than a range of recording power in which the recording data error rate is lower than or equal to the allowable level “L de.” As a consequence, it can be understood that the track error signal can satisfy a predetermined allowable value if the changing range of the recording power is properly set, even in such a case that the recording power is changed so as to achieve the optimum recording condition.

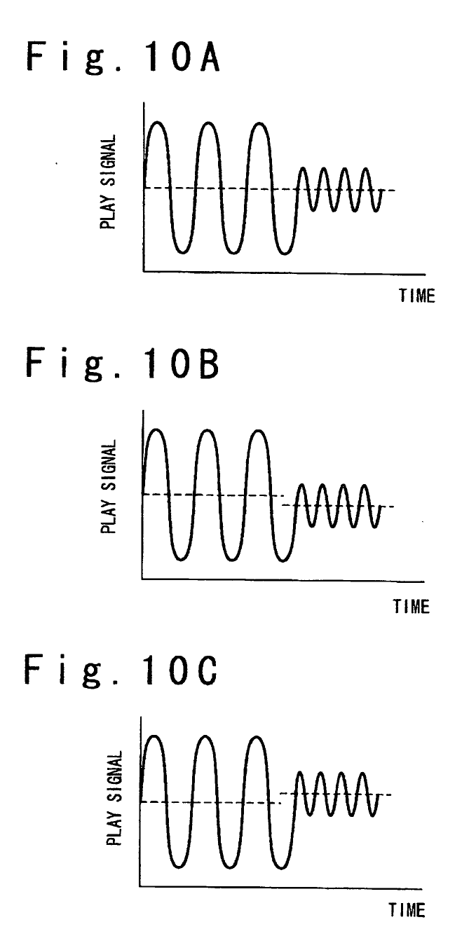

FIGS. 10A to 10C show examples of a method for seeking optimum recording power. The following fact is known. That is, when recording power is changed in the vicinity of an optimum value, a shift of an averaged reproducing signal level is generated between a recording signal of a long-term period and a recording signal of a short-term period. The shift of the averaged reproducing signal level is generally known as an “asymmetrical value”. Under such a condition that recording power is optimum, the recording signal of the long term period and the recording signal of the short term period have substantially a same averaged value, as shown in FIG. 10A. As shown in FIG. 10B, when the recording power becomes higher than the optimum power, the averaged value of the recording signal of the short term period is shifted to a smaller value side than the averaged value level of the recording signal of the long term period. Conversely, as shown in FIG. 10C, when the recording power becomes lower than the optimum power, the averaged value of the recording signal of the short term period is shifted to a larger value side than the averaged value level of the recording signal of the long term period. As a consequence, if a specific pattern is recorded in the control data to be reproduced while the recording power is slightly changed, then the optimum recording power in the vicinity of this recording position can be grasped.

In FIGS. 10A to 10C, the specific pattern has been employed. Instead, a random pattern such as a user data may be employed. In this case, an asymmetrical value can be detected from an eye-pattern of a reproduction signal in a similar manner.

The above example indicates an example that the recording power is adjusted. Instead, an edge timing data such as a jitter may be detected so as to adjust a recording strategy condition such as a pulse width.

Also, as to timing at which the control data is recorded, as shown in FIG. 12, when the recording position reaches the control data recording portion while a series of user data are recorded, the control data may be recorded. Further, after an adjusting operation of the recording condition has been carried out in each of predetermined control data recording portions, the control data may be recorded.

In any of these cases, if the data-recorded portions are continued without any gap at a time when the series of data recording operations are accomplished, then no problem may occur in the reproducing apparatus.

As previously mentioned, since the recording power is properly adjusted in a half way of the writing operation to the data area, the stable recording operation can be realized. Also, even when the advance mode is merely employed to record the recording management data, but is not used to adjust the recording power, the necessity of accessing the remote lead-in area may be decreased since the recording management data may be arranged close to the user data which is additionally recorded. Thus, the stable track tracing operation can be realized. As a result, there is a merit that the recording quality may be improved.

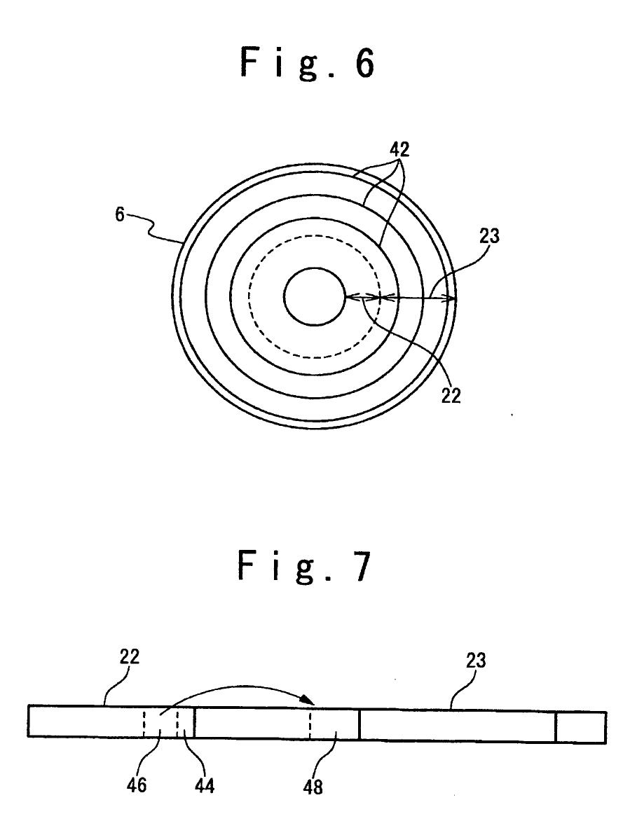

A second embodiment of the present invention is a method in which a flag is set to the lead-in area 22 and a position where the control data is recorded is previously determined. Referring to FIG. 6, the second embodiment will be described.

The structure of the recording type optical disk apparatus according to the second embodiment of the present invention is identical to that of the first embodiment. Therefore, the description of this structure is omitted.

In the second embodiment, a flag area 44 is set to a lead-in area 22. In the flag area 44, a flag indicative of the normal mode in which a series of user data which have been encoded are recorded in a continuous manner or a flag indicative of the advance mode, in which the control data which does not contain any user data is recorded because it is used for an access control in the recording operation. In this case, data indicating where the control data is located in the data recording area 23 is separately required. As the simplest method for indicating the position of the control data, there is a method for previously determining a position (address) of a data recording area which is used for the control data.

In the optical disk medium 6 shown in FIG. 6, a plurality of areas 42 where the control data will be recorded are arranged in a substantially constant interval along the radial direction of this optical disk medium 6 in the data recording area 23. Since the areas 42 where the control data will be recorded have been previously set, addresses indicative of positions of these areas 42 have been fixed. The fixed addresses are previously stored in the disk controller 14 or the CPU 10, and one fixed address is compared with an address to which data is tried to be read/written. Thus, based on the comparing result, it is possible to determine that this area is an area where user data will be recorded or another area where the control data will be recorded.

In this case, since the areas are utilized to optimize the recording condition, it is desirable to set a plurality of positions for these areas 42. For example, when the areas 42 where the control data will be recorded are allocated in an interval of 2 mm along a radial direction, approximately 20 areas 42 where the control data will be recorded can be arranged within the optical disk medium having a diameter of 12 cm. At this time, the number of tracks (circumferential number) which are allocated to one area 42 where the control data is recorded becomes in a range of 5 to 10 circumferences which are required to seek a recording condition.

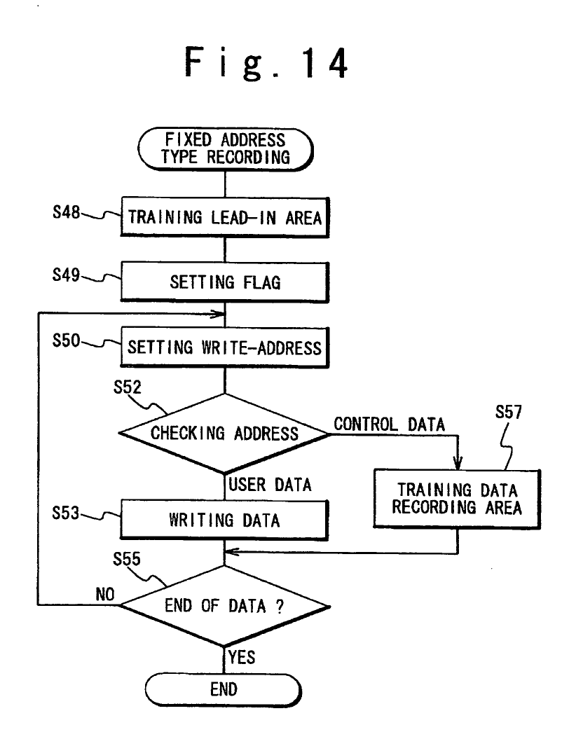

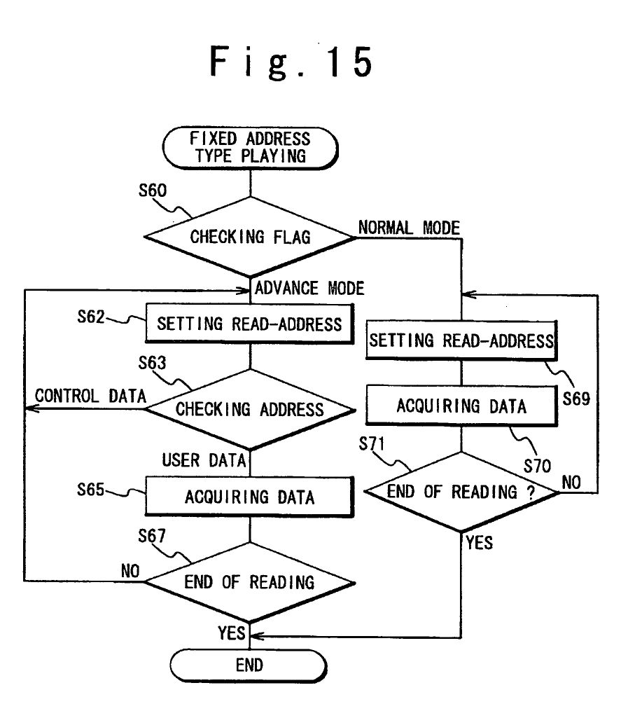

Referring to FIG. 14, a recording operation when addresses of areas where the control data is recorded are fixed will be described. Similar to the above-mentioned first embodiment, a single cession is employed in the writing operation.

First, the lead-in area 22 is written. The calibration (training) operation for recording laser power is carried out based upon data in the area for the recording management data (RMA) which is required for the recording appliance, and the calibration (PCA) operation of the recording laser power, which has been secured in the R-Information area of the lead-in area 22. Thus, an optimum recording condition is set (step S48).

Data corresponding to an index is set to the lead-in area 22. Also, a flag indicating that data is recorded in the advance mode is written into a predetermined position (step S49).

Subsequently, the user data or the control data is written into the data recording area 23. First, an address used to write the data into the optical disk medium 6 is set to the disk controller 14 (step S50).

Whether or not the write address is same as the control data write address which has been previously set is checked (step S52).

If the write address is not same to the previously-set control data write address (namely, “user data” in step S52), then the above-mentioned user data is written into this portion (step S53).

If the write address is same to the previously-set control data write address (namely, “control data” in step S52), then the control data of a specific pattern is written into this portion. Then the calibration (training) operation of the recording laser power is carried out, and an optimum recording condition is set (step S57).

Next, whether or not all of the user data have been written is checked (step S55). If the check result becomes “NO”, then the steps from the step S50 to the step S55 are repeatedly carried out until all of the user data are written.

Next, a reproducing operation for reading out the user data from the optical disk medium 6, which has been written in the above-mentioned manner, will be described with reference to FIG. 15. The optical disk medium 6 is mounted on the optical disk apparatus 4, and the reproducing operation is commenced.

First, the flag is read out from the lead-in area 22. Then, the read out flag is checked on whether this read out flag indicates a normal mode in which a series of the encoded user data are continuously recorded, or the advance mode in which the control data is recorded in the data recording area 23 during the recording operation (step S60).

When the read out flag indicates the advance mode (namely, “advance mode” in step S60), the area that the control data has been recorded is present in the data recording area 23 where the user data has been recorded. As a result, when a read address is set to the disk controller 14 (step S62), a judgment is made as to whether or not the read address indicates the area where the control data has been recorded (step S63).

When the read address indicates the area where the control data has been recorded (namely, “control data” in step S63), the data of this area is skipped (not read), and the reproducing operation is returned to the previous step S62 in which an address of a next area is set.

When the read address does not indicate the area where the control data has been recorded (namely, “user data” in step S63), the data of this area is acquired or read out (step S65). While the read data is continued, the reproducing operation is returned to the previous step S62, the above-mentioned processes are repeatedly carried out (“NO” in step S67).

On the other hand, when the optical disk medium 6 indicates the normal mode (namely, “normal mode” in step S60), the conventional reading operation is carried out. The read address is set to the disk controller 14 (step S69), and the user data is acquired from an area which is indicated by this read address (step S70). While the read data is continued, the reproducing operation is returned to the previous step S69. The above-mentioned processes are repeatedly carried out (“NO” in step S71).

As previously mentioned, in this second embodiment, the data can be read out from the optical disk medium 6 by carrying out the different reproducing operation based on the recording mode indicated by the flag of this optical disk medium 6. If the recording mode is previously determined, the data can be read in accordance with the sequential operation from the step S69 to the step S71. Thus, compatibility between the optical disk medium 6 which has been recorded in accordance with the conventional method and the above-mentioned optical disk medium 6 where the flag has been recorded can be secured. That is, when the flag has not been recorded on the optical disk medium 6, namely in case of the optical disk medium 6 which data has been recorded in accordance with the conventional method, it is determined that the recording mode of this optical disk medium 6 is the normal mode.

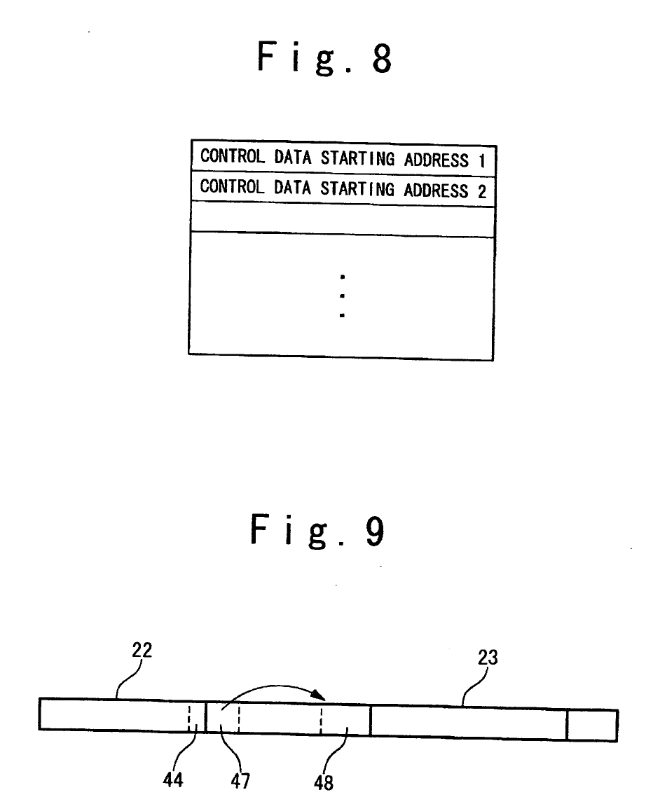

The third embodiment of the present invention is a method in which a flag is set to the lead-in area 22 and a position is determined where the control data will be recorded when data is recorded. Referring to FIGS. 7 and 8, the third embodiment will be described. It should be noted that the structure of the recording type optical disk apparatus according to the third embodiment of the present invention is identical to that of the first embodiment. Therefore, the description of this arrangement is omitted.

In the third embodiment, a flag area 44 for recording a flag indicative of the normal mode and the advance mode is set to a lead-in area 22. In the normal mode, a series of user data which have been encoded are recorded in a continuous manner. In the advance mode, the control data which does not contain the user data is recorded for an access control in the recording operation. In this case, the data indicating where the control data is located within the data recording area 23 is separately required. As the simplest method for indicating the position of the control data, there is a method that when the write data is recorded in the data recording area 23, a position (address) of the data recording area used for the control data is determined, and the determined position for the control data is recorded in a predetermined area.

As shown in FIG. 7, an area 48 where the control data will be recorded is set within the data recording area 23, whereas the flag area 44 and the address table 46 are set within the lead-in area 22.

The area 48 where the control data will be recorded is utilized to carry out an access control operation during the recording operation. Therefore, this area 48 does not contain user data. As the data to be recorded in this area 48, the previously-set specific pattern data or random pattern data is used. The flag area 44 is an area where a flag is recorded. This flag indicates that the optical disk medium 6 is a medium which has been recorded in the normal mode, or another medium which has been recorded in the advance mode. The address table 46 is an area as shown in FIG. 8, in which addresses of the areas 48 where the control data will be recorded have been registered.

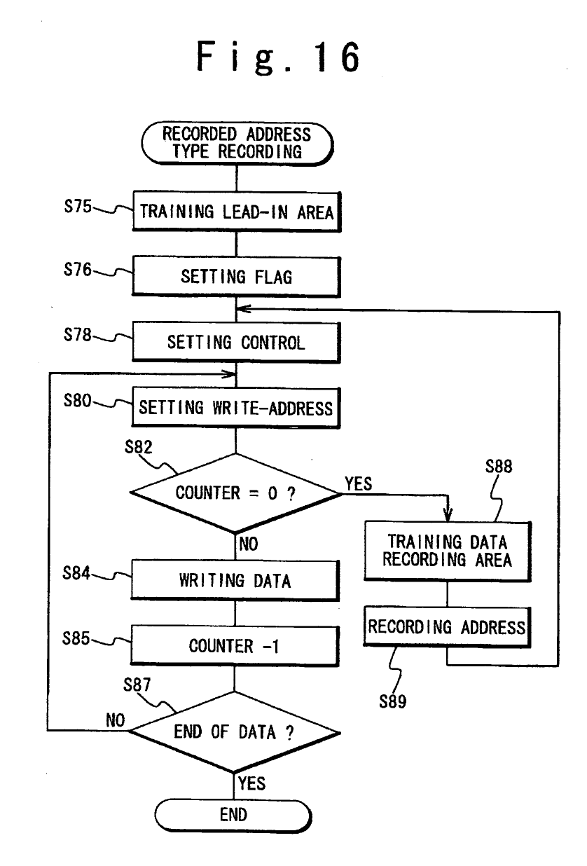

The recording operation which is carried out the optical disk medium 6 having the above-mentioned data structure will be described with reference to FIG. 16. Similar to the above-mentioned first embodiment, a single cession is employed in the recording operation. First, the lead-in area 22 is written in a similar manner to the second embodiment. The calibration (training) operation for recording laser power is carried out based upon data of the area of the recording management data (RMA) which is required for the recording appliance, and the calibration (PCA) operation of the recording laser power, which has been secured in the R-Information area of the lead-in area 22. Thus, an optimum recording condition is set (step S75).

The data corresponding to an index of write data is set to the lead-in area 22. Also, a flag indicating that the data is recorded in the advance mode is written into a predetermined position (step S76).

Subsequently, the user data or the control data is written into the data recording area 23. In the third embodiment, it is assumed that every time the predetermined number of user data is written in the data recording area 23, the control data is written. To this end, the disk controller 14 or the CPU 10 is provided with a counter (not shown) for counting the total number of recorded user data. The preselected number “N” is set to the counter (step S78).

An address used to write data into the optical disk medium 6 is set to the disk controller 14 (step S80).

A check is made of a counted content of this counter in order to determine whether or not the counter content is equal to a number (=0) at which the control data is written (step S82). As a result of this determination, if the counted value is not equal to the number (=0) at which the control data is written (“NO” in step S82), then the user data is written into this portion (step S84).

Since the user data is written, the counter is decrement (−1) (step S85). The processes from the step S80 to the present step are repeatedly carried out until the recording operation of the user data is accomplished (“NO” in step S87).

As a result of this determination, if the counted value is equal to the number (=0) at which the control data is written (“YES” in step S82), the control data is written. The control data of the specific pattern is written to perform the calibration (training) operation of recording laser power. Thus, an optimum recording condition is set (step S88). The address at which the control data has been written is recorded in the address table 46 (step S89). Thereafter, the processes from the step S78 in which the counter is set are repeatedly carried out.

Apparently, as the control data, not the calibration of the recording laser power but the recording management data may be employed.

When the addresses are recorded on the address table 46, this address recording operation need not be carried out at the same time when the control data is written. Instead, these addresses may be once stored in the CPU 10, and after all of the user data have been recorded, these addresses may be collectively recorded in the address table 46. Further, the addresses of areas where the control data will be written are previously set, and these addresses may be later recorded in the address table 46. In this case, the determination of whether or not the control data is written may be carried out based upon not a count value but a condition of whether or not an address of an area where the control data is written is coincident with a control data writing address.

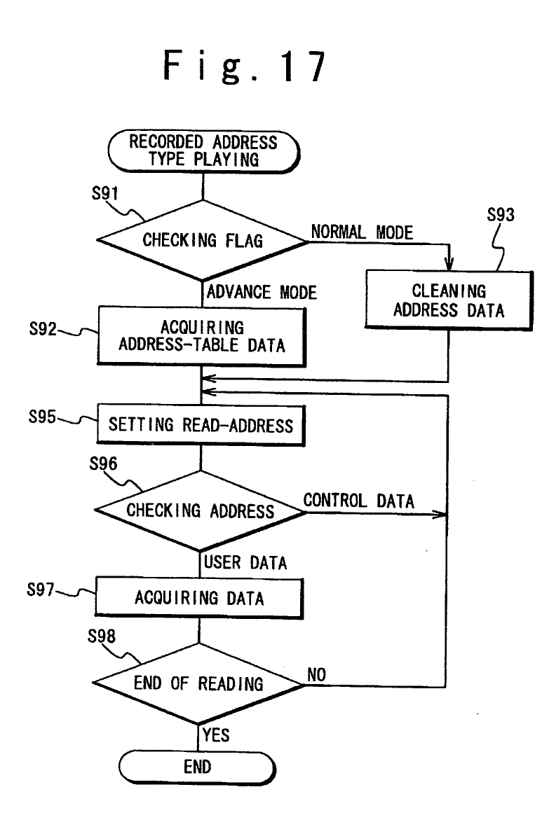

Next, a reproducing operation to the optical disk medium 6 to which the recording operation has been recorded in the above-described manner will be described with reference to FIG. 17. The optical disk medium 6 is mounted on the optical disk apparatus 4, and the reproducing operation is commenced.

First, a flag is read out from the lead-in area 22, and the read flag is checked as follows. That is, this read flag indicates the normal mode in which a series of the encoded user data are continuously recorded, or the advance mode in which the control data is recorded in the data recording area 23 during the recording operation (step S91).

When the read flag indicates the advance mode (namely, “advance mode” in step S91), an address for indicating an area that the control data has been recorded is read out from the address table 64, and this read address is stored into the disk controller 14 or the CPU 10 (step S92). It should be understood that although the addresses need not be read from the address table 46 at once, reading time can be shortened if the addresses are read at once during the transport of the access unit 12.

When the read flag shows the normal mode (namely, “normal mode” in step S91), since no control data is recorded in the data recording area 23, the address is cleared which indicates the area where the control data has been recorded, which should be stored in the disk controller 14 or the CPU 10.

When the address for representing the area where the control data has been recorded is set to the disk controller 14 or the CPU 10, a data reading operation is commenced. First, an address used to read the data is set to the disk controller 14 (step S95).

A check is made as to whether or not the read address is an address at which the stored control data has been recorded (step S96). When the read address is coincident with the address at which the control data has been recorded (namely, “control data” in step S96), the data of this read address is skipped (not read), and the reproducing operation is returned to the previous step S95 at which data of a next address is read out.

When the read address is not coincident with the address at which the control data has been recorded (namely, “user data” in step S96), data is acquired from the area which is indicated by this read address (step S97). The reproducing operation is repeatedly carried out until the read data is accomplished (step S98).

As previously mentioned, the user data may be reproduced from the optical disk medium 6 in which the control data has been recorded in the data recording area 23.

As previously mentioned, when the address of the position of the control data is recorded in the lead-in area 22, there is a merit that the position of the control data can be freely set. At this time, this merit may be utilized as a replacing process function. That is, in this replacing process function, the normal area may be used with respect to an error as a defect occurred in the data recording area 23.

Also, in the third embodiment, the address table 46 is secured in the lead-in area 22. Instead, as shown in FIG. 9, an address table 47 may be secured at a head portion of a data recording area 23. In this case, the operations are basically identical to the operations described in the third embodiment.

In any of these cases, in order to commonly use formats of these ROMs with a format of a reproducing-only ROM as being permitted as possible, a similar flag area may be preferably set to the format of the ROM. In case of ROMs, since no data is recorded, all of these ROMs are operated in the normal mode.

Also, as addresses to be recorded, physical addresses may be employed which have been previously formed in a recording type disk in a wobble manner, or addresses of data IDs which are applied to a series of user data may be employed. Although the employment of the physical addresses has a merit that these physical addresses may be processed within the drive, such a function capable of recognizing the physical addresses is required in the reproducing drive. In the latter address case, although the recognition of the physical address is not required, the function capable of recognizing the address of the data ID corresponding to the control data is required in an upper-layer system.

Conventionally, in a rewritable type optical disk apparatus, the recording operations have been carried out in such a manner that address tables indicative of defect areas have been previously formed, and data are recorded by skipping the defect areas when the data are recorded. When the data is reproduced, such a defect area skipping operation is also carried out, which is identical to that of the present invention. However, in accordance with the present invention, the data must be recorded in the area which is allocated to this control data, so that an unrecorded portion which has been produced in the conventional defect skipping portion is not produced. Also, in the reproducing apparatus, the table referring operation is continuously required, which may cause a failure in such a case that a fast information transfer speed is required on the reproduction side. However, in accordance with the present invention, since the normal mode without using the control data may also be selected, there is a merit that this normal mode may be alternatively utilized, depending upon the purpose.

1. An optical disk medium comprising a lead-in area and a data recording area,
wherein said data recording area comprises:
a user data area where a user data is recorded which is to be recorded by a user; and
a control data area where a control data is recorded, said control data being used in an access control operation of said optical disk medium.

2. The optical disk medium according to claim 1, further comprising:
a flag area where a flag is recorded and provided to indicate that said control data has been recorded in said data recording area.

3. The optical disk medium according to claim 2, wherein said flag area is provided for at least one pit.

4. The optical disk medium according to claim 2, wherein said data recording area comprises:
a plurality of ECC (Error Correction Code) blocks, and
said flag area is provided in each of said plurality of ECC blocks.

5. The optical disk medium according to claim 4, wherein said flag area is provided in a head portion of each of said plurality of ECC blocks.

6. The optical disk medium according to claim 2, wherein said flag area is provided in said lead-in area.

7. The optical disk medium according to claim 2, wherein an address table is recorded in said lead-in area, and
when said flag indicates that said control data has been recorded in said data recording area, said control data is recorded in an area which is indicated based on an address of said data recording area recorded in said address table.

8. The optical disk medium according to claim 2, wherein an address table is recorded in said data recording area, and
when said flag indicates that said control data has been recorded in said data recording area, said control data is recorded in an area which is indicated based on an address of said data recording area recorded in said address table.

9. The optical disk medium according to claim 7, wherein said address is indicated by a physical address of said optical disk medium, which has been previously formed.

10. The optical disk medium according to claim 7, wherein said address is indicated based on an ID (identification) for identifying each of said plurality of ECC blocks.

11. The optical disk medium according to claim 1, wherein said control data contains a predetermined pattern data.

12. The optical disk medium according to claim 11, wherein said predetermined pattern data comprises random data.

13. An optical disk apparatus for reproducing a user data from an optical medium including a lead-in area and a data recording area in which a recording data having said user data and a control data is recorded, comprising:
an access unit configured to read said recording data from said data recording area; and
a control unit configured to control said access unit such that said user data of said recording data is selectively read out from said optical medium.

14. An optical disk apparatus for recording a user data on an optical medium including a lead-in area and a data recording area in which a recording data having said user data and a control data is recorded, comprising:
an access unit configured to record said recording data into said data recording area; and
a control unit configured to change a recording condition of said access unit, when the control data is recorded on the data recording area.

15. The optical disk apparatus according to claim 14, further comprising:
a host unit which outputs an instruction to said control unit such that said access unit carries out a training before a recording process, and
wherein said control unit determines an optimized recording condition of said access unit based on the changed recording condition.

16. The optical disk apparatus according to claim 15, wherein said control data and said user data are recorded on said data recording area of said optical medium by said access unit in response to the instruction from said host unit, and
said control unit controls said access unit to record a flag data on said optical medium, when said control unit detects that said control data and said user data are already recorded on said optical medium.

17. The optical disk apparatus according to claim 16, wherein said control unit controls said access unit in response to another instruction of said host unit to record said flag data in each of ECC blocks of said data recording area of said optical medium.

18. The optical disk apparatus according to claim 17, wherein said control unit controls said access unit in response to said another instruction from said host unit to record said flag data in a head portion of each of said ECC blocks of said data recording area.

19. The optical disk apparatus according to claim 16, wherein said control unit controls said access unit in response to another instruction of said host unit to record said flag data in said lead-in area of said optical media.
